(19) United States
(12) Patent Application Publication
(10) Pub. No.: US 2026/0242245 A1
(43) Pub. Date: Aug. 20, 2026

(54) POOL SYSTEM WITH FREE CHLORINE ELECTROCHEMICAL SENSOR WITH PH CONTROL

(71) Applicant: Zodiac Pool Systems LLC, Carlsbad, CA (US)

(72) Inventors: Anthony Levacque, Carlsbad, CA (US); Guillermo Codina, Carlsbad, CA (US); Taylor Kuter, Carlsbad, CA (US); Mark J. Bauckman, San Marcos, CA (US)

(73) Assignee: Zodiac Pool Systems LLC, Carlsbad, CA (US)

(21) Appl. No.: 19/535,561

(22) Filed: Feb. 10, 2026

Related U.S. Application Data
(60) Provisional application No. 63/759,770, filed on Feb. 18, 2025.

(51) Int. Cl. C02F 1/00; C02F 1/76; C02F 103/42

(52) U.S. Cl. CPC C02F 1/008; C02F 1/76; C02F 2103/42; C02F 2209/06; C02F 2209/29

(57) ABSTRACT

A pool system includes a water sensing device. The water sensing device may locally control a pH of a sensing region of the water sensing device including water of a pool or spa. Additionally, or alternatively, the water sensing device may electrochemically sense free chlorine in the sensing region after locally controlling the pH of the sensing region.

### REFERENCE TO RELATED APPLICATION

This application claims the benefit of and priority to U.S. Provisional Patent Application No. 63/759,770, filed on Feb. 18, 2025, and entitled POOL SYSTEM WITH FREE CHLORINE ELECTROCHEMICAL SENSOR WITH PH CONTROL, the content of which is hereby incorporated by reference in its entirety.

### FIELD OF THE INVENTION

The invention relates to water testing or monitoring systems, and more particularly, but not necessarily exclusively, to water testing or monitoring systems for swimming pools or spas.

### BACKGROUND OF THE INVENTION

Maintaining water quality is important for swimming pools, spas, hot tubs, and other water containing vessels (hereinafter “swimming pools or spas”) to avoid issues for users of the pool as well as equipment of the pool. For example, if the water chemistry of the swimming pool or spa is off, a health hazard may be posed to users and/or operation of various pool equipment and/or systems may be compromised. Conventional testing of water may measure water parameters such as pH, chlorine, total chlorine, total alkalinity, and/or cyanuric acid.

With specific reference to chlorine, chlorine levels are monitored in residential pools or spas because low chlorine levels may result in ineffective disinfection of the pool water while high chlorine levels may cause adverse health effects to occupants of the pool or spa. A number of techniques or methods are available for residential monitoring of chlorine levels, but such existing techniques suffer from various drawbacks and limitations. For example, monitoring chlorine levels using a colorimetric method utilizing DPD (N, N-diethyl-p-phenylenediamine) requires a user to interpret a change in color to determine chlorine concentrations (a subjective interpretation), may lack precision at high chlorine concentrations, and relies on reagents which degrade over time (thereby affecting efficiency). Techniques for monitoring chlorine levels utilizing test strips similarly rely on a user's subjective interpretation of a change in color, and such test strips are further influenced by water impurities, thereby leading to inaccurate readings. Methods utilizing electrochemical sensors (chlorine meters) traditionally rely on expensive and complex equipment (and thus are not traditionally used on residential pools), require calibration and maintenance, and may be affected by temperature and pH changes, leading to inaccurate results. Titration methods for monitoring chlorine levels are time-consuming and require careful procedures, thereby making them ill-suited for residential users and frequent testing, and further require full titration kits and chemicals which may degrade over time, thereby affecting accuracy of the results. Methods based on oxidation reduction potential (ORP) measurements do not provide a direct measurement of free chlorine, require calibration, and may be influenced by other oxidizing agents, interferents (e.g., cyanuric acid), and/or pH changes. Techniques utilizing spectrophotometry require expensive and specialized equipment, are not practical for everyday use in small pools, and are time-consuming compared to other techniques.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a pool system includes a water sensing device, and the water sensing device is adapted to (i) locally control a pH of a sensing region of the water sensing device including water of a pool or spa and (ii) electrochemically sense free chlorine in the sensing region after locally controlling the pH of the sensing region.

According to various embodiments, a pool system includes a water sensing device configured to (i) convert residual chlorine species in a sensing region of the water sensing device with water of a pool or spa to one species of residual chlorine and (ii) electrochemically sense free chlorine in the sensing region after converting the residual chlorine to the one species of residual chlorine.

According to some embodiments, a method includes locally controlling a pH of a sensing region of a water sensing device with water of a pool or spa, electrochemically detecting free chlorine in the sensing region after locally controlling the pH of the sensing region, and generating an output response based on the detected free chlorine.

According to certain embodiments, non-transitory computer readable storage medium includes a plurality of instructions executable by one or more processors, the plurality of instructions including instructions which, when executed by the one or more processors, cause the one or more processors to perform actions including obtaining a free chlorine measurement using a water sensing device by locally controlling a pH of a sensing region of the water sensing device with water of a pool or spa and electrochemically detecting free chlorine in the sensing region after locally controlling the pH of the sensing region. The instructions may further cause the one or more processors to perform actions including generating an output response based on the detected free chlorine.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system with a water sensing device according to embodiments.

FIG. 2 illustrates a portion of the water sensing device of FIG. 1 according to embodiments.

FIG. 3 illustrates a portion of the water sensing device of FIG. 1 according to embodiments.

FIG. 4 illustrates the pool system of FIG. 1 with additional water sensing devices according to embodiments.

### DETAILED DESCRIPTION

Described herein are pool systems and methods providing improved free chlorine measurement and optional control based on such measurements. In certain embodiments, the systems and methods described herein include a water sensing device with a sensing region for receiving water from a pool or spa. The water sensing device may (i) locally control a pH of the sensing region with the water of a pool or spa and (ii) electrochemically sense or measure free chlorine in the sensing region after locally controlling the pH of the sensing region. The water sensing device may be various pool equipment, a component of existing pool equipment, a dedicated piece of pool equipment, and/or at various locations in or relative to a pool or spa as desired. As non-limiting examples, the water sensing device may be a handheld device that is mobile relative to the pool or spa, a device that is buoyant and/or configured to float at a waterline of the pool or spa, a device that is movable (e.g., self-propelled or passively) within the pool or spa, a device that is fixed relative to the pool or spa, a device at a fixed location in the circulation system of the pool or spa, a device with an adjustable location within the circulation system, a flow cell within the circulation system, combinations thereof, and/or as otherwise desired.

Optionally, the systems and methods described herein may generate an output response based on the sensed or measured free chlorine. Generating an output responses may include, but is not limited to, one or more of generating an alert or notification on the water sensing device, sending an alert or notification to a remote device, controlling another piece of pool equipment, and/or saving the measurements in a storage device of the water sensing device and/or of a remote device.

Compared to traditional approaches, the pool systems and methods described herein may provide improved sensing of free chlorine in the pool or spa that is both accurate and user-friendly. The systems and methods described herein optionally may be utilized indirectly for the determination of the pH of the water from the pool or spa. Various other benefits and advantages may be realized with the systems, devices, and methods provided herein, and the aforementioned advantages should not be considered limiting.

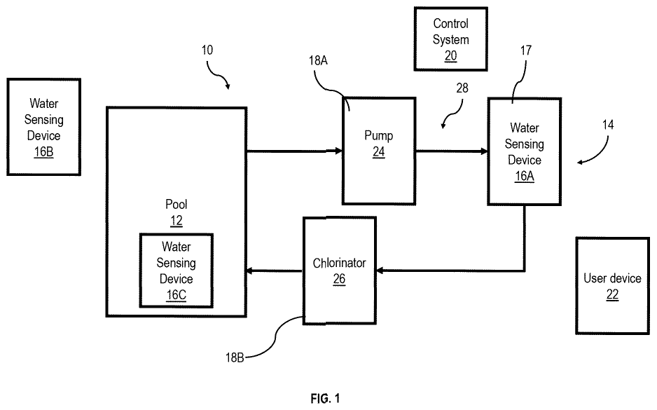

FIG. 1 illustrates an example of a pool system 10 according to embodiments. The pool system 10 generally includes a pool or spa 12 (hereinafter “pool 12”) and a monitoring system 14 with one or more water sensing devices 16 for measuring free chlorine in water of the pool 12 as discussed in detail below. In addition to the monitoring system 14, the pool system 10 may include one or more pieces of pool equipment 18. Non-limiting examples of pool equipment 18 may include a pump 24, a filter, a heater, a chlorinator 26, a sanitation system (such as but not limited to a UV system), combinations thereof, and/or as otherwise desired.

Optionally, the pool system 10 includes one or more control systems 20, which may be independent and/or provided with one or more pieces of pool equipment, for controlling one or more operations of the pool system 10 and/or communicating with a user as desired. The control system 20 may include one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data. In certain embodiments, the control system 20 optionally includes an associated user interface, including but not limited to a graphical user interface or a human machine interface, such that the control system 20 may obtain information from a user and/or provide information to the user. In such embodiments, the user interface and/or human machine interface may be on the control system 20 itself or may be at a location remote from the control system 20.

In various embodiments, and with reference to FIG. 1, the various components of the pool system 10 (and/or sub-combinations thereof) may be communicatively coupled. In these embodiments, information, such as but not limited to calcium hardness measurement information, may be directly or indirectly communicated between various components of the pool system 10. Such communication, whether direct or indirect, may utilize various communication techniques as desired, such as but not limited to wired communication and/or wireless communication (e.g., Bluetooth, Li-Fi, LoRa, radio frequency, cellular, NFC, Wi-Fi, etc.). In some embodiments, and as discussed in detail below, the components of the pool system 10 may be communicatively coupled such that at least chlorine measurements from the water sensing device(s) 16 may be communicated to one or more other devices or systems.

FIG. 1 illustrates three water sensing devices 16—water sensing device 16A is provided in line with a circulation system 28 of the pool system 10 (including the pump 24), water sensing device 16B is a handheld device, which is mobile relative to the pool 12, and water sensing device 16C is a device configured to float within the pool 12. In a non-limiting example, water sensing device 16A may be a flow cell 17 within the circulation system 28. However, the number and particular types of water sensing devices 16 illustrated should not be considered limiting, and in other embodiments, the pool system 10 may include any number and/or any combination of types of water sensing devices 16 as desired, including one water sensing device 16, two water sensing devices 16, or more than two water sensing devices 16. As non-limiting examples, water sensing devices 16 may additionally or alternatively be self-propelled within the pool 12, passively movable within the pool 12, at a fixed location within the pool 12, at a fixed location in the circulation system 28, at an adjustable or changeable location within the circulation system 28, a dedicated water sensing device, a component of another piece of pool equipment 18 (e.g., a pool cleaner, a skimmer, a pump, etc.), combinations thereof, and/or as otherwise desired.

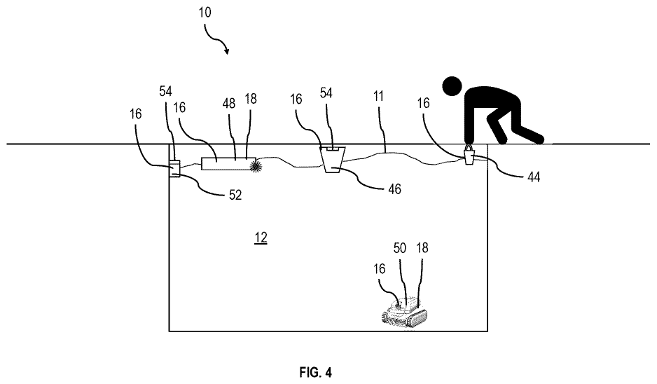

FIG. 4 illustrates non-limiting examples of water sensing devices 16 according to embodiments. As illustrated in FIG. 4, the water sensing devices 16 may include a handheld device 44, a passively floating (or buoyant) device 46 configured to float at or proximate to a waterline 11 of the pool 12, a self-propelled floating device such as but not limited to a skimmer 48, a self-propelled submergible device such as but not limited to a pool cleaner 50, and/or a device 52 at a fixed location on and/or within the pool 12, such as but not limited to on a wall 13 of the pool 12. The number and type of water sensing devices 16 illustrated in FIG. 4 should not be considered limiting.

In some embodiments, and as illustrated in FIG. 4, the one or more water sensing devices 16 optionally may include an onboard user interface 54 such that information may be directly communicated to a user and/or received from a user. Additionally, or alternatively, the one or more water sensing devices 16 may communicate via wired and/or wireless communication techniques with another device or system, such as the control system 20, the user device 22, other pool equipment 18, combinations thereof, and/or as otherwise desired, such that the measurements obtained by the water sensing devices 16 may be provided to other equipment and/or remote users as desired.

Each water sensing device 16 is generally adapted to electrochemically sense free chlorine in a sample of water from the pool 12. Free chlorine in water from the pool 12 may exist in one of two forms—hypochlorous acid and hypochlorite—which traditionally have different reactivities for different sensors. The ratio of hypochlorous acid and hypochlorite is dependent on the pH of the water, and as an example, free chlorine may predominantly exist as hypochlorite when the pH is more basic and may predominantly exist as hypochlorous acid when the pH is more acidic. In various embodiments and as discussed in detail below, to provide measurements of chlorine in the water of the pool 12 with improved accuracy and sensitivity, the water sensing device 16 may locally control the pH in a sensing region 30 of the water sensing device 16 such that the chlorine is predominately of the same form (e.g., predominately hypochlorous acid or predominantly hypochlorite) and then electrochemically sense the chlorine in the sensing region 30.

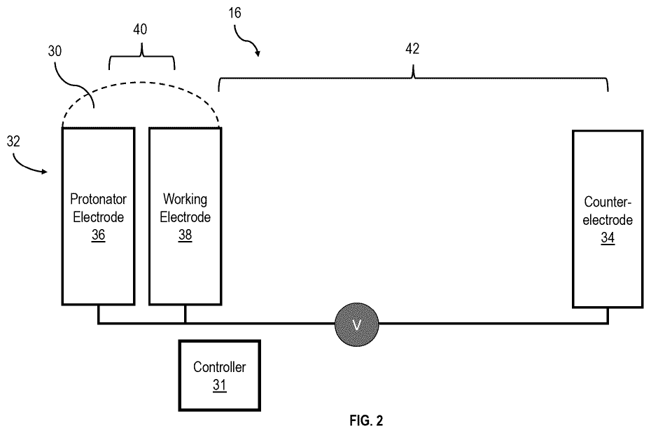

Referring to FIG. 2, in certain embodiments, each water sensing device 16 generally includes the sensing region 30 which may receive water from the pool 12 and/or be exposed to water of the pool 12. The water sensing device 16 generally includes an electrode array 32 and a counter electrode 34. The electrode array 32 defines the sensing region 30 and generally includes a protonator electrode 36 and a sensing electrode 38. In certain embodiments, the electrode array 32 is an interdigitated electrode array, although other configurations of electrode arrays may be utilized as desired. The electrodes 34, 36, 38 may be constructed from various materials as desired. As non-limiting examples, the electrodes 34, 36, 38 may by constructed from various metals, such as but not limited to gold (Au), silver (Ag), platinum (Pt), copper (Cu), titanium (Ti), aluminum (Al), alloys thereof, combinations thereof, and/or other materials as desired.

In certain embodiments, the electrodes 36, 38 of the electrode array 32 are spaced apart by a first distance 40, and the counter electrode 34 is spaced apart from the sensing region 30 by a second distance 42 which is greater than the first distance. As non-limiting examples, the first distance 40 may be less than 10 μm, such as less than 9 μm, such as less than 8 μm, such as less than 7 μm, such as less than 6 μm, such as less than 5 μm, such as less than 4 μm, such as less than 3 μm, such as less than 2 μm, such as less than 1 μm. In other embodiments, the first distance 40 may be other distances as desired. As other non-limiting examples, the second distance 42 may be at least 0.1 mm, such as at least 0.2 mm, such as at least 0.3 mm, such as at least 0.4 mm, such as at least 0.5 mm, such as at least 0.6 mm, such as at least 0.7 mm, such as at least 0.8 mm, such as at least 0.9 mm, such as at least 1.0 mm, such as at least 1.1 mm. In certain embodiments, the second distance 42 is a distance sufficient such that the consumption of protons by the counter electrode 34 does not occur too close to the sensing electrode 38. In various embodiments, the first distance 40 is a distance such that pH control is established by the rapid diffusion of protons without requiring additional forces (e.g., convection, fluidic, etc.).

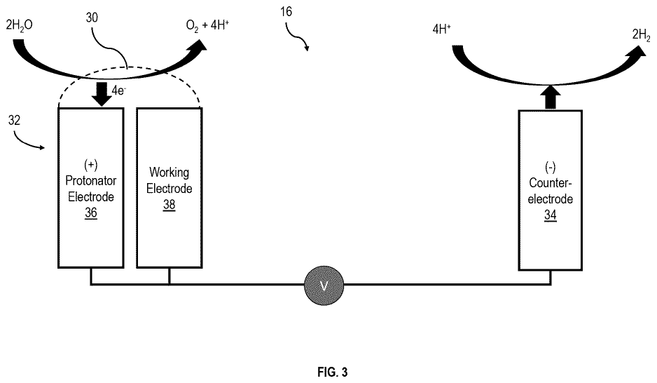

In various embodiments, the water sensing device 16 is controlled (e.g., by an onboard controller 31, the control system 20, and/or as otherwise desired) such that an appropriate potential is imposed at the protonator electrode 36, thereby causing a local pH to change in the water in the sensing region 30 (e.g., to become more acidic or more basic as desired and/or based on the desired form of chlorine to be detected). After locally changing the pH, the sensing electrode 38 may be utilized to sense the free chlorine in the sensing region 30. As a non-limiting example, the sensing electrode 38 may be configured for sensing free chlorine in the hypochlorous acid form, and the water sensing device 16 is controlled such that the pH of the water in the sensing region is locally more acidic compared to water of the pool that is not within the sensing region 30 (e.g., by imposing a positive electrical potential at the protonator electrode 36). As another non-limiting example, the sensing electrode 38 may be configured for sensing free chlorine in the hypochlorite form, and the water sensing device 16 may be controlled such that the pH of the water in the sensing region 30 is locally more basic compared to water of the pool that is not within the sensing region 30 (e.g., by imposing a negative electrical potential at the protonator electrode 36). FIG. 3 illustrates a non-limiting example illustrating the protonator electrode 36 with a positive electrical potential, thereby making the pH of the water in the sensing region 30 more acidic.

As such, by controlling the protonator electrode 36, the pH at the sensing electrode 38 may be controlled and/or tailored as desired, thereby facilitating electrochemical-based detection of chlorine. Various techniques may be utilized for electrochemical-based detection, such as but not limited to linear sweep voltammetry, cyclic voltammetry, and/or chronoamperometry. As non-limiting examples, the pH of the sensing region 30 may be controlled to be more acidic or basic as desired, thereby causing chlorine to be predominantly in the form of hypochlorous acid or hypochlorite and allowing for electrochemical-based detection of chlorine via linear sweep voltammetry with improved accuracy and sensitivity.

Optionally, the electrochemical-based detection of chlorine may be utilized to indirectly determine the pH of the sensing region 30. As a non-limiting example, based on the detection of hypochlorous acid, the water sensing device 16 (and/or control system 20) may determine that the specific control of the protonator electrode 36 resulted in the sensing region 30 to have a pH of 0.5, 1, 2, 2.5, etc. In some embodiments, such feedback may be further utilized to control the protonator electrode 36 such that the sensing region 30 has a desired pH.

The chlorine detected by the water sensing device(s) 16 may be utilized by the water sensing device(s) 16, the control system 20, and/or other equipment 18 for generating various output responses. As non-limiting examples, the chlorine measurements may be stored in a storage medium for future reference and/or future analysis by the water sensing device(s) 16 and/or the control system 20, may be communicated to the user device 22, may be used to generate an alert (e.g., if chlorine levels are too low and/or too high) on the water sensing device 16, the control system 20, the user device 22, and/or as otherwise desired, may be used (e.g., by the control system 20 or as otherwise desired) to control operation of one or more pieces of pool equipment 18, may be used to prompt servicing by a technician, combinations thereof, and/or as otherwise desired.

As a non-limiting example, the control system 20 may obtain or receive at least the chlorine measurement from the water sensing device 16 and provide an output response to the pool equipment 18 (e.g., provide the chlorine measurement and/or a control signal based on the chlorine measurement to the pool equipment 18). In some embodiments, the chlorine measurement and/or the control signal based on the chlorine measurement optionally may be utilized to control operation, an operating parameter, and/or performance of the pool equipment 18.

As non-limiting examples, the chlorine measurement and/or control signal may be utilized to control operation of the pump 24 (e.g., modify pump performance and/or as otherwise desired), control operation of the pool cleaner and/or skimmer (e.g., control navigation, cleaning pattern, and/or as otherwise desired), and/or control operation of a sanitization system, and/or control operation of the chlorinator, among others. As yet another non-limiting example, the chlorine detected by the water sensing device(s) 16 may be provided to a user via the user interface 54 on the water sensing device 16 (if present), such as an alert, notification, and/or as otherwise desired.

Additionally, or alternatively, the control system 20 may be communicatively coupled to the user device 22, such as but not limited to a phone, tablet, computer, and/or other device as desired, optionally running an application, and the control system 20 may obtain or receive at least the chlorine measurement from the water sensing device 16 and generate an output response for the user device 22. Optionally, such output responses may include generating an alert, notification, and/or as otherwise desired on the user device 22. Additionally, or alternatively, the water sensing device(s) 16, piece(s) of pool equipment 18, and/or user device(s) 22 may directly communicate with each other and/or with the user (e.g., via the user interface, if present). Various other communication and between various groups of components may be utilized using the pool system 10 described herein, and the aforementioned examples should not be considered limiting.

As mentioned, in certain embodiments, the monitoring system 14 described herein advantageously provides improved sensing of chlorine levels in the pool 12 by locally controlling a pH of a sensing region of the water sensing device with water of a pool or spa and electrochemically detecting free chlorine in the sensing region after locally controlling the pH of the sensing region. Various other benefits and advantages may be realized with the systems, devices, and methods provided herein, and the aforementioned advantages should not be considered limiting.

Exemplary concepts or combinations of features of the invention may include:
A. A pool system comprising a water sensing device, the water sensing device configured to (i) locally control a pH of a sensing region of the water sensing device including water of a pool or spa and (ii) electrochemically sense free chlorine in the sensing region after locally controlling the pH of the sensing region.
B. A pool system comprising a water sensing device, the water sensing device configured to (i) convert residual chlorine species in a sensing region of the water sensing device with water of a pool or spa to one species of residual chlorine, and
   (ii) electrochemically sense free chlorine in the sensing region after converting the residual chlorine to the one species of residual chlorine.
C. A method comprising:
   i. locally controlling a pH of a sensing region of a water sensing device with water of a pool or spa;
   ii. electrochemically detecting free chlorine in the sensing region after locally controlling the pH of the sensing region; and
   iii. generating an output response based on the detected free chlorine.
D. A non-transitory computer readable storage medium comprising a plurality of instructions executable by one or more processors, the plurality of instructions comprising instructions which, when executed by the one or more processors, cause the one or more processors to perform actions including:
   i. obtaining a free chlorine measurement using a water sensing device by
      i. locally controlling a pH of a sensing region of the water sensing device with water of a pool or spa; and
      ii. electrochemically detecting free chlorine in the sensing region after locally controlling the pH of the sensing region; and
      iii. generating an output response based on the detected free chlorine.
E. The pool system, method, or instructions of any preceding or subsequent statements or combination of statements, wherein the water sensing device is a handheld device and mobile relative to the pool or spa.
F. The pool system, method, or instructions of any preceding or subsequent statements or combination of statements, wherein the water sensing device is buoyant and/or configured to float at a waterline of the pool or spa.
G. The pool system, method, or instructions of any preceding or subsequent statements or combination of statements, wherein the water sensing device is self-propelled within the pool or spa.
H. The pool system, method, or instructions of any preceding or subsequent statements or combination of statements, wherein the water sensing device is at a fixed location within a circulation system of the pool or spa.
I. The pool system, method, or instructions of any preceding or subsequent statements or combination of statements, wherein the water sensing device is a flow cell within the circulation system of the pool or spa.
J. The pool system, method, or instructions of any preceding or subsequent statements or combination of statements, further comprising a control system and a water treatment system, wherein the water sensing device is communicatively coupled to at least the control system, and wherein the control system is configured to control the water treatment system based on the free chlorine detected by the water sensing device.
K. The pool system, method, or instructions of any preceding or subsequent statements or combination of statements, wherein the water sensing device comprises an electrode array and a counter electrode, wherein the electrode array defines the sensing region, wherein the electrode array comprises a protonator electrode and a sensing electrode, and wherein the protonator electrode is configured to impose an electrical potential in the sensing region to locally control the pH and the sensing electrode is configured to sense the free chlorine.
L. The pool system, method, or instructions of any preceding or subsequent statements or combination of statements, wherein the electrode array is an interdigitated electrode array.
M. The pool system, method, or instructions of any preceding or subsequent statements or combination of statements, wherein the electrodes of the electrode array are spaced apart by a first distance which is less than a second distance from the sensing region to the counter electrode.
N. The pool system, method, or instructions of any preceding or subsequent statements or combination of statements, further comprising a controller configured to control the electrical potential.
O. The pool system, method, or instructions of any preceding or subsequent statements or combination of statements, wherein the controller is configured to control the electrical potential to increase acidity in the sensing region.
P. The pool system, method, or instructions of any preceding or subsequent statements or combination of statements, wherein the controller is configured to control the electrical potential to decrease acidity in the sensing region.
Q. The pool system, method, or instructions of any preceding or subsequent statements or combination of statements, wherein the one species of residual chlorine is hypochlorous acid.
R. The pool system, method, or instructions of any preceding or subsequent statements or combination of statements, wherein generating the output response comprises controlling an operating parameter of a piece of pool equipment.
S. The pool system, method, or instructions of any preceding or subsequent statements or combination of statements, wherein generating the output response comprises controlling a maintenance parameter of a piece of pool equipment.
T. The pool system, method, or instructions of any preceding or subsequent statements or combination of statements, wherein generating the output response comprises generating an alert or notification to a user.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with swimming pools or spas, persons skilled in the relevant field will recognize that the present invention conceivably could be employed in connection with other water containing vessels and in other manners, particularly but not limited to underwater installations. Finally, references to “pools” and “swimming pools” herein may also refer to spas or other water containing vessels used for recreation, training, or therapy.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “102A” refers to an instance of a device class, which may be referred to collectively as devices “102” and any one of which may be referred to generically as a device “102”. In the figures and the description, like numerals are intended to represent like elements. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

That which is claimed:

1. A pool system comprising a water sensing device configured to:
(i) locally control a pH of a sensing region of the water sensing device including water of a pool or spa; and
(ii) electrochemically sense free chlorine in the sensing region after locally controlling the pH of the sensing region.

2. The pool system of claim 1, wherein the water sensing device is a handheld device and mobile relative to the pool or spa.

3. The pool system of claim 1, wherein the water sensing device is buoyant and/or is configured to float at a waterline of the pool or spa.

4. The pool system of claim 1, wherein the water sensing device is self-propelled within the pool or spa.

5. The pool system of claim 1, wherein the water sensing device is at a fixed location within a circulation system of the pool or spa.

6. The pool system of claim 5, wherein the water sensing device is a flow cell within the circulation system of the pool or spa.

7. The pool system of claim 1, further comprising a control system and a water treatment system, wherein the water sensing device is communicatively coupled to at least the control system, and wherein the control system is configured to control the water treatment system based on the free chlorine detected by the water sensing device.

8. The pool system of claim 1, wherein the water sensing device comprises an electrode array and a counter electrode, wherein the electrode array defines the sensing region, wherein the electrode array comprises a protonator electrode and a sensing electrode, and wherein the protonator electrode is configured to impose an electrical potential in the sensing region to locally control the pH and the sensing electrode is configured to sense the free chlorine.

9. The pool system of claim 8, wherein the electrode array is an interdigitated electrode array.

10. The pool system of claim 8, wherein the electrodes of the electrode array are spaced apart by a first distance which is less than a second distance from the sensing region to the counter electrode.

11. The pool system of claim 8, further comprising a controller configured to control the electrical potential.

12. The pool system of claim 11, wherein the controller is configured to control the electrical potential to increase acidity in the sensing region.

13. The pool system of claim 11, wherein the controller is configured to control the electrical potential to decrease acidity in the sensing region.

14. A method comprising:
locally controlling a pH of a sensing region of a water sensing device with water of a pool or spa;
electrochemically detecting free chlorine in the sensing region after locally controlling the pH of the sensing region; and
generating an output response based on the detected free chlorine.

15. The method of claim 14, wherein generating the output response comprises controlling an operating parameter of a piece of pool equipment.

16. The method of claim 14, wherein generating the output response comprises controlling a maintenance parameter of a piece of pool equipment.

17. The method of any of claim 14, wherein generating the output response comprises generating an alert or notification to a user.

18. A non-transitory computer readable storage medium comprising a plurality of instructions executable by one or more processors, the plurality of instructions comprising instructions which, when executed by the one or more processors, cause the one or more processors to perform actions including:
obtaining a free chlorine measurement using a water sensing device by
i. locally controlling a pH of a sensing region of the water sensing device with water of a pool or spa; and
ii. electrochemically detecting free chlorine in the sensing region after locally controlling the pH of the sensing region; and
generating an output response based on the detected free chlorine.

19. The non-transitory computer readable storage medium of claim 18, wherein generating the output response comprises controlling an operating parameter of a piece of pool equipment.

20. The non-transitory computer readable storage medium of claim 18, wherein generating the output response comprises generating an alert or notification to a user.
